(19) United States
(12) Patent Application Publication
(10) Pub. No.: US 2005/0112279 A1
(43) Pub. Date: May 26, 2005

(54) DYNAMIC RELEASE WAFER GRIP AND METHOD OF USE

(75) Inventor: Frederick W. Kern Jr., Colchester, VT (US)

Correspondence Address: MCGUIRE WOODS LLP, 1750 TYSONS BLVD., SUITE 1800, MCLEAN, VA, 22102-4215, US

(73) Assignee: INTERNATIONAL BUSINESS MACHINES CORPORATION, Armonk, NY (US)

(21) Appl. No.: 10/707,150

(22) Filed: Nov. 24, 2003

(51) Int. Cl. B05D 3/12; B05C 11/02

(52) U.S. Cl. 427/240; 427/425; 118/52; 118/320

(57) ABSTRACT

A system and method for processing a workpiece which prevents processing variations and contaminations on the workpiece. The system and method permits processing fluids to flow off a surface of the workpiece unimpeded. The method and system includes providing a plurality of contacts for holding the workpiece during a processing or fabrication. During the processing, the contacts are released from the workpiece in order to allow the fluids to flow off a surface of the workpiece. A control may be used to control the movements of the contacts toward and away from the workpiece to engage and release the workpiece, respectively.

### BACKGROUND OF INVENTION

1. Field of the Invention

The invention generally relates to a gripping mechanism to hold a workpiece during workpiece fabrication and, more particularly, to gripping mechanisms and a method of use which reduces process variations and contamination during wafer fabrication processing.

2. Background Description

To fabricate microelectronic devices such as an integrated circuit (IC), many different processes are used to achieve the final product. By way of example, in fabrication processes, it is known to use processing fluids such as, for example, chemicals, plating solutions, photoresists and the like on the wafer. To accomplish these processes, the wafer is typically held on a rotating chuck by grips that locate a wafer on its edges. But, it is known that these grips disrupt the uniform flow of processing fluids radially outward. This leads to inconsistencies in the processing near the areas of contact with the grips. This can also result in the accumulation of particulate contamination due to the stagnation of flow in the vicinity of grips, as well as shadowing effects.

Being more specific, in a single wafer application, the single wafer is placed on a rotating chuck of a processing machine. The wafer is held in place by three stationary gripping mechanisms, which contact an edge of the wafer about a radial edge. The grips allow the wafer to be rotated on the rotating chuck during fabrication thus ensuring that the wafer remains stationary. During the rotation of the chuck, processes are performed on the wafer to reach a final product. These processes may include, for example, the application of photoresists in order to form, for example, channels, isolation features and the like. Other chemicals are also used during the fabrication processes such as, for example, etching solutions, plating solutions and the like.

However, during the application of these fluids, it is known that the grips interfere with the processing of the wafer. That is, since the stationary grips are always in contact with the wafer, the wafer process suffers from process variations and or contamination around the grips. This is due to physical obstruction by the grips or, in some instances, capillary trapping. In either case, this results in yield deficiencies, higher manufacturing costs and other known problems.

Another problem arises during the acceleration phase of the workpiece, depending on a particular processing stage. For example, during a drying stage, rotational speeds of the workpiece may be about 2500 RPM. However, to obtain such speeds, there are accelerations that are applied to the workpiece. During these accelerations, certain forces, i.e., tangential forces, act on the workpiece such that the workpiece may shift from the rotating chuck. In known systems, however, stationary gripping mechanisms are used to maximize the contact area and thus maximize any frictional issues. But, in such systems there is a compromise between the grip area and impedance to flow of the process fluid; namely, the more contact area required to hold the workpiece stationary the more impedance to flow exists. Also, it is known that these grips may not by sufficient to prevent the shifting of the workpiece during the acceleration phase.

### SUMMARY OF INVENTION

In a first aspect of the invention, a method for processing a workpiece is provided. The method includes providing a plurality of contacts for holding the workpiece and processing a surface of the workpiece. During the processing step, the method includes releasing at least one of the contacts.

In embodiments, the plurality of contacts comprises a first set of three contacts and a second set of three contacts.

The first set remains in contact with the workpiece and the second set are released from the workpiece. The first set holds the workpiece and during the processing step processing fluids are unimpeded to flow off a surface of the workpiece at the locations on the workpiece where the second set of contacts is released therefrom. This similar situation occurs for the first set when released from the workpiece. In embodiments, the contacts are released for a predetermined amount of time and then moved into engagement with the workpiece for holding the workpiece.

In another aspect of the invention, a method for processing a workpiece includes rotating a workpiece at a predetermined speed and providing a plurality of gripping mechanisms for holding the workpiece. The surface of the workpiece is processed with processing fluids. At least one of the plurality of gripping mechanisms is released from the workspace during the processing step and then moved into contact. Also, another of the plurality of gripping mechanisms is released from the workpiece during the processing step.

In still another aspect of the invention, the method for processing a workpiece includes moving alternately gripping mechanisms of the plurality of gripping mechanisms away from and into contact with the workspace during processing to allow processing fluids to freely flow, unimpeded, from a surface of the workpiece at previous locations of the released gripping mechanisms. In this aspect, in embodiments, the moving step includes moving alternately non-adjacent gripping mechanisms.

In yet another aspect of the invention, a system is provided for processing a workpiece. The system includes a plurality of moveable gripping mechanisms being moveable between a holding position and a releasable position with respect to a workpiece and a mechanism for controlling alternating movement of the moveable gripping mechanisms away from and into contact with the workspace during processing. This system allows processing fluids to freely flow, unimpeded, from a surface of the workpiece at previous locations of the released gripping mechanisms.

### BRIEF DESCRIPTION OF DRAWINGS

FIG. 1 shows a top view of a gripping mechanism in accordance with the invention;

FIG. 2 shows a cross sectional view along line 2-2 of FIG. 1; and

FIG. 3 shows a control of the system in accordance with the invention.

### DETAILED DESCRIPTION

This invention is directed to a gripping mechanism to hold a workpiece during fabrication and, more particularly, to gripping mechanisms and a method of use which reduces process variations and contamination during wafer fabrication. In the invention, the gripping mechanisms are used to grip the workpiece, and in one implementation, a wafer on a rotating chuck. During the fabrication processes and more particularly during the application of processing fluids, each individual gripping mechanism is designed to radially move outward to release from the workpiece. Likewise, the individual gripping mechanisms also move radially inward to grip the workpiece during the fabrication processes. In the invention, during the fabrication processes, some of the gripping mechanisms will always remain in contact with the workpiece to hold the workpiece (e.g., wafer) to the rotating chuck, while other gripping mechanisms are released from the wafer to prevent contamination problems. Thus, by using the invention, accumulation of particulate contamination due to the stagnation of flow in the vicinity of the gripping mechanisms can be eliminated. Also, shadows (e.g., under etching or failure to remove the photoresist) in the areas of the gripping mechanisms, themselves, are also eliminated using the invention.

In one example, the gripping mechanisms are alternated between an engaged and disengaged position, i.e., moved toward and away from the workpiece to hold and release the workpiece, respectively, during fabrication or other processing. The movement of the gripping mechanisms toward and away from the workspace can be accomplished in many different ways, as contemplated by the invention. In one such configuration, by example, six gripping mechanisms may be used with the invention. During the fabrication of the workpiece, three gripping mechanisms may be used to hold the workpiece while three gripping mechanisms may be released or disengaged from the workpiece. Thereafter, the three released gripping mechanisms may be moved to hold the workpiece, at which time, the other three gripping mechanisms are moved away or disengaged from the workpiece. But, now the processing fluids will no longer accumulate on the workpiece causing contaminations since the gripping mechanisms alternately are released or disengaged from the workpiece. Thus, by this process, there is an increase in the device yield as well as reduction of overall costs, including manufacturing and material costs.

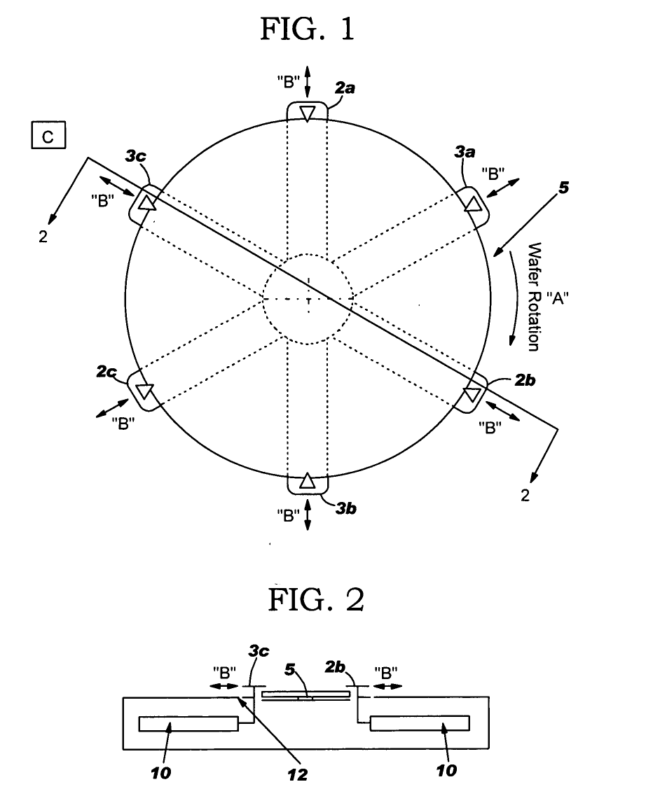

Referring to FIG. 1, a top view of an implementation of the invention is shown. In particular, a workpiece 1 is shown mounted on a chuck 5 by several movable gripping mechanisms. The movable gripping mechanisms may be triangular or rounded in shape, for example. In the implementation shown, the workpiece 1 may be a wafer or may equally be a CD, DVD or other type of fabricated workpiece. As shown in FIG. 1, there are six movable gripping mechanisms 2a, 2b, 2c, 3a, 3b and 3c which are capable of alternately hold and release the workpiece about a periphery edge thereof. The movable gripping mechanisms are moved toward and away from the workpiece, e.g., into and out of engagement, by an air cylinder or bell crank, for example, as shown in FIG. 2. In other implementations, five movable gripping or finger mechanisms can be implemented with the invention to hold the workpiece during fabrication of either side thereof. It should also be understood by those of ordinary skill in the art that more than six movable gripping mechanisms may be implemented with the invention.

Still referring to FIG. 1, each of the movable gripping mechanisms may be individually controlled by the appropriate hardware or software controls, as depicted by control “C”. The workpiece 1, held on the rotating chuck 5 by each of the gripping mechanisms, may be rotated in the direction of arrow “A”, controlled by the control “C”, in one implementation. As shown by arrows “B”, the gripping mechanisms 2a, 2b, 2c, 3a, 3b and 3c are moved into and out of contact or engagement with the periphery of the workpiece 1, again, in one implementation, controlled by the control “C”.

The control may be implemented by computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

In one implementation, a minimum of three movable gripping mechanisms are required to locate and hold the workpiece at any one time. For example, as controlled by the control “C”, as the workpiece is processed, the grip-ping mechanisms 2a, 2b and 2c may be used to grip the workpiece. At this time, the gripping mechanisms 3a, 3b and 3c are released or disengaged from the workpiece. During the fabrication process, the processing fluids, which normally are prevented from moving radially off of the workpiece surface, either by physical obstruction or capillary trapping, can now flow off the surface of the workpiece in the areas where the movable gripping mechanisms 3a, 3b and 3c are disengaged or released from the workpiece. This is because the movable gripping mechanisms 3a, 3b and 3c will no longer provide any interference with the processing fluids.

In another stage, during the same fabrication process, the movable gripping mechanisms 2a, 2b and 2c may be released from the workpiece while the movable gripping mechanisms 3a, 3b and 3c are moved into engagement with the workpiece. The movable gripping mechanisms 3a, 3b and 3c are now used to hold the workpiece to the chuck. But, in this manner, processing fluids that are typically prevented from moving radially off of the workspace can now freely move off of the surface during the rotation of the chuck, or otherwise, at the locations of the movable gripping mechanisms 2a, 2b and 2c. It should now be understood by those of ordinary skill in the art, though, that some of the movable gripping mechanisms are always holding the workpiece to the chuck. Thus, there is no possibility that the workpiece will shift or be released from the chuck during rotation or other fabrication processes.

In other implementations, each of the movable gripping mechanisms or other combinations of gripping mechanisms may be moved to release and hold the workpiece onto the chuck, depending on the processing stage and processing fluids being used by the system. This may be controlled by the control “C”, which is preprogrammed with a sequence of the processing. By way of example, the gripping mechanisms 2a, 2b, 2c, 3a and 3b may be used to grip or hold the workspace during a fabrication stage. During this stage, the gripping mechanism 3c may be released or disengaged from the workpiece. Then, in order, the gripping mechanism 3b may be released or disengaged while the gripping mechanism 3c is moved to engage and hold the workpiece with the remaining gripping mechanisms. Alternatively, the gripping mechanism 3c may remain disengaged from the workpiece and will be moved toward the holding position, as shown in FIG. 1, after the gripping mechanism 3a is disengaged from the workpiece such that three of the gripping mechanisms are moved simultaneously towards the workpiece and into engagement for holding the workpiece to the chuck. In any of these scenarios, the removal of any of the movable gripping mechanisms, occurring during the fabrication process such as, for example, during the application of processing fluids, will prevent physical obstruction or capillary trapping of the processing fluids. This is because movable gripping mechanisms will no longer provide any interference with the processing fluids.

In a more definite example, it is contemplated by the invention that all movable gripping mechanisms will be used, initially, during the acceleration of the chuck. Once the rotation of the chuck has reached a desired speed, then the gripping mechanisms may be released, depending on variables such as time of processing, type of processing fluid and the like, as implemented by the control “C”. In one implementation, the following may be used for a fabrication process:
A chemical such as, for example, hydrochloric and nitric acid is used to thin the wafer. In one implementation, the hydrochloric and nitric acid is dispensed at about 50 mil./minute at a rotational speed of about 50 to 100 RPM for about five minutes.
During the acceleration phase, all of the movable gripping mechanisms are engaged with the workpiece to hold the workpiece to the chuck. This provides additional frictional forces to retain the workpiece on the chuck during the acceleration stage.
Once the chuck reaches its desired speed, the chemicals will be dispensed onto the workpiece. The rotation of the workpiece evenly distributes the chemicals over the surface of the workpiece. The rotational speed also, due to radial forces of rotation, assists the chemicals in flowing off of the surface of the workpiece.
Once at the desired speed, the movable gripping mechanisms are alternated between the gripping and release positions. In one implementation, for illustration, the movable gripping mechanisms 2a, 2b and 2c will alternately be removed and engaged with the workpiece with the movable gripping mechanisms 3a, 3b and 3c about every thirty seconds. (It should be understood, though, that this cycle may depend on the fabrication process, properties of fluids and the like.) This will eliminate or substantially reduce process variations and contamination during wafer fabrication process.
In this implementation, once the chemical cycle ends, all of the movable gripping mechanisms are engaged with the workpiece for the next processing stage, which is the rinse stage.
Prior to the rinse stage, the rotational speed of the workpiece is increased to about 100 to 250 RPM for about three minutes. This, of course, results in an acceleration of the workpiece. The movable gripping mechanisms, however, provide additional frictional forces to retain the workpiece on the chuck during this acceleration phase.
Once at the desired rotation speed, the rinse phase will start using, for example, deionized water at about 100 mil./minute for about three minutes.
The movable gripping mechanisms are again alternated in a manner similar to above for about every ten seconds, for the three minutes.
In this implementation, once the rinse cycle ends, all of the movable gripping mechanisms are then engaged with the workpiece for the next processing stage, which is the drying stage.
Prior to the drying stage, the rotational speed of the workpiece is increased to about 1000 to 2500 RPM for about three to five minutes. This, of course, results in an acceleration of the workpiece. The movable gripping mechanisms, however, provide additional frictional forces to retain the workpiece on the chuck during this acceleration phase.
Once at the desired rotation speed, the drying phase will start. The movable gripping mechanisms are again moved in an alternated manner similar to above for about every 90 to 150 seconds, at which time the processing ends.

It should be understood, though, that the above is provided for illustration and that other configurations, depending on, for example, the properties of the fluid, may affect the processing times and sequential or alternating release of the movable gripping mechanisms. For example, a photoresist, which is a more viscous material, may be used as a processing fluid. In this example, the workpiece may be rotated at about 500 RPM. In this implementation, the movable gripping mechanisms may each or a set of move in an alternated manner about every five to ten seconds since the photoresist has a tendency to dry on the surface of the workpiece. In any scenario, the control “C” will be programmed with the desired parameters, known to those implementing the system and method of the invention, for ensuring that the processing fluids freely flow from the surface of the workpiece, unimpeded.

FIG. 2 shows a cross sectional view along line 2-2 of FIG. 1. This view shows one structure contemplated for moving the gripping mechanisms into and out of engagement with the workpiece 1. The structure includes an air cylinder 10, but may include a bell crank or other systems such as, for example, a rack and pinion gear. Upon activation, for example, air can be provided into the air cylinder to move the gripping mechanism into or out of engagement with the workpiece. The air cylinder 10 is attached to the gripping mechanism via a slot. The slot is of such a length and nature as to allow the movable gripping mechanisms to move into an out of engagement with the workpiece on the rotating chuck 5.

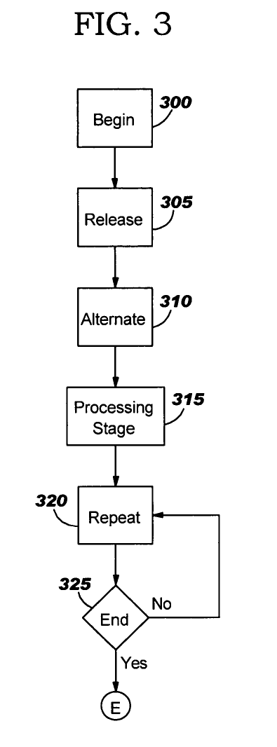

FIG. 3 is a flow diagram showing one implementation of the method of the invention. The flow diagram may equally represent a high level block diagram of the invention. The steps of the flow may be implemented by computer program code in combination with the appropriate hardware. As with the control “C”, this computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

At step 300, the fabrication process begins. This process may include, for example, the application of processing fluids such as photoresists, chemical polishers, and the like. At first, in one implementation, all of the movable gripping mechanisms engage or hold the workpiece during the acceleration of the chuck. Once a desired speed is achieved, at step 305, one or more of the movable gripping mechanisms are released from the workpiece during the application of the processing fluids. During the rotation, the processing fluids are evenly distributed on the workpiece due to the rotational forces generated by the rotating chuck. Also, the processing fluids are able to freely flow off the surface of the workpiece. At step 310, the movable gripping mechanisms are all alternated so that some are engaged while others are removed from the workpiece.

At step 315, a next processing phase begins by, for example, accelerating the workpiece. At this stage, all of the movable gripping mechanism may be used to hold the workpiece to the chuck. At step 320, steps 305 and 310 are repeated. At step 325, a determination is made as to whether the fabrication process has ended. If not, then step 315 and step 320 is repeated. If the fabrication is completed, then the process ends at “E”.

The system and method of the invention ensures that some of the movable gripping mechanisms also hold the workpiece during the rotation of the chuck. This may be accomplished by, for example,
the control being programmed with the number of gripping mechanisms initially provided on the system, and
the control keeping track of each of the gripping mechanisms which are released and engaged with the workpiece.

Of course, a check can be implemented by the system to ensure that there are movable gripping mechanisms holding the workpiece to the chuck, preferably three in one implementation.

Depending on each implementation, the logic of the system may be preprogrammed with the order and time periods for moving the movable gripping mechanisms into engagement with the workpiece and releasing the movable gripping mechanism from the workpiece. In one implementation, at some time, each of the movable gripping mechanism are to be released from the workpiece to ensure that the processing fluids are free to flow off of the surface of the workpiece, unimpeded.

It should also be recognized by those of ordinary skill in the art that the movable gripping mechanisms may be moved in a number or sequences. For example, the control “C” may be programmed to:
individually move one movable gripping mechanism at a time in a sequence into and out of engagement with the workpiece to allow the processing fluids to flow from the surface, unimpeded, at the location of each of the removed gripping mechanisms, and/or
move any combination of movable gripping mechanisms into and out of engagement with the workpiece to allow the processing fluids to flow from the surface, unimpeded, at the location of each of the removed movable gripping mechanisms.

While the invention has been described in terms of embodiments, those skilled in the art will recognize that the invention can be practiced with modifications and in the spirit and scope of the appended claims.

1. A method for processing a workpiece, comprising the steps of:
providing a plurality of contacts for holding the workpiece;
processing a surface of the workpiece;
releasing at least one of the contacts during the processing step; and
keeping track, with a control, of each of the plurality of contacts which are released and engaged with the workpiece.

2. The method of claim 1, wherein the plurality of contacts grip a periphery of the workpiece such that an upper and a lower surface of the workpiece are exposed to processing.

3. The method of claim 1, wherein the plurality of contacts comprises a first set of three contacts and a second set of three contacts.

4. The method of claim 3, wherein the first set remains in contact with the workpiece and the second set is released from the workpiece.

5. The method of claim 4, wherein the first set holds the workpiece and during the processing step processing fluids are unimpeded to flow off a surface of the workpiece at the locations on the workpiece where the second set of contacts is released therefrom.

6. The method of claim 4, wherein after the first set is in contact with the workpiece and the second set is released from the workpiece, the first set is released from the workpiece and the second set is moved into contact with the workpiece.

7. The method of claim 6, wherein the second set holds the workpiece and during the processing step processing fluids are unimpeded to flow off a surface of the workpiece at the locations on the workpiece where the first set of contacts is released therefrom.

8. The method of claim 3, wherein the first set includes contacts located at a first, third and fifth position along a periphery of the workpiece and the second set includes contacts located at a second, fourth and sixth position along the periphery of the workpiece.

9. The method of claim 1, wherein the workpiece is rotating during the processing step.

10. The method of claim 1, further comprising the step of accelerating the workpiece and each of the plurality of contacts holds the workpiece during the acceleration step.

11. The method of claim 1, wherein each of the plurality of contacts is separately released from and moved into contact with the workpiece in a sequential order.

12. The method of claim 1, wherein each of the plurality of contacts is separately released from and moved into contact with the workpiece in an alternating order.

13. The method of claim 1, wherein the plurality of contacts comprises five contacts, releasable in a predetermined sequence.

14. The method of claim 1, wherein the processing step includes providing a processing fluid on a surface of the workpiece.

15. The method of claim 1, wherein the at least one of the contacts is released for a predetermined amount of time and then moved into engagement with the workpiece for holding the workpiece.

16. The method of claim 1, wherein the processing step includes drying a surface of the workpiece.

17. The method of claim 1, wherein at least three contacts of the plurality of contacts hold the workpiece.

18. A method for processing a workpiece, comprising the steps of:
rotating a workpiece at a predetermined speed;
providing a plurality of gripping mechanisms for holding the workpiece;
processing a surface of the workpiece with processing fluids;
releasing at least one of the plurality of gripping mechanisms from the workpiece during the processing step;
moving the at least one of the plurality of gripping mechanisms into contact with workpiece;
releasing another of the plurality of gripping mechanisms from the workpiece during the processing step; and
keeping track, with a control, of each of the plurality of gripping mechanisms which are released and engaged with the workpiece.

19. The method of claim 18, wherein the plurality of gripping mechanisms comprises a first set of three gripping mechanisms and a second set of three gripping mechanisms.

20. The method of claim 19, wherein the first set remains in contact with the workpiece and the second set is released from the workpiece.

21. The method of claim 20, wherein:
the first set holds the workpiece and during the processing step processing fluids are unimpeded to flow off a surface of the workpiece at the locations on the workpiece where the second set is released therefrom; and
after the first set is in contact with the workpiece and the second set is released from the workpiece, the first set is released from the workpiece and the second set is moved into contact with the workpiece such that processing fluids are unimpeded to flow off a surface of the workpiece at the locations on the workpiece where the first set is released therefrom.

22. The method of claim 19, wherein the first set includes contacts located at a first, third and fifth position along a periphery of the workpiece and the second set includes contacts located at a second, fourth and sixth position along the periphery of the workpiece.

23. The method of claim 19, wherein the at least one of the plurality of gripping mechanisms is released for a predetermined amount of time and then moved into engagement with the workpiece for holding the workpiece.

24. The method of claim 18, wherein each of the plurality of gripping mechanisms is separately released and moved into contact with the workpiece in one of a sequential or alternating order.

25. (Currently Amended) A method for processing a workpiece, comprising the steps of:
providing a plurality of gripping mechanisms for holding the workpiece during a rotation of the workpiece;
moving alternately gripping mechanisms of the plurality of gripping mechanisms away from and into contact with the workspace during processing to allow processing fluids to freely flow, unimpeded, from a surface of the workpiece at previous locations of the released gripping mechanisms; and
keeping track, with a control, of each of the plurality of gripping mechanisms which are released and engaged with the workpiece.

26. The method of claim 25, wherein the processing includes providing a processing fluid to the surface of the workpiece which is distributed on the surface of the workpiece by the rotation of the workpiece.

27. The method of claim 25, wherein the moving step includes moving alternately non-adjacent gripping mechanisms.

28. The method of claim 27, wherein the moving step includes:
moving a first, third and fifth position gripping mechanisms away from the workpiece while a second, fourth and sixth position gripping mechanisms holds the workpiece; and
moving the first, third and fifth position gripping mechanism toward the workpiece and the second, fourth and sixth position gripping mechanisms toward the workpiece to hold the workpiece.

29-30. (canceled)

31. A method for processing a workpiece, comprising the steps of:
providing a plurality of contacts for holding the workpiece;
processing a surface of the workpiece;
releasing at least one of the contacts during the processing step;
keeping track, with a control, of each of the plurality of contacts which are released and engaged with the workpiece; and
one of:
each of the plurality of contacts is separately released from and moved into contact with the workpiece in a sequential order; and
each of the plurality of contacts is separately released from and moved into contact with the workpiece in an alternating order.
